(19) United States
(12) Patent Application Publication
(10) Pub. No.: US 2009/0254391 A1
(43) Pub. Date: Oct. 8, 2009

(54) USE OF HISTORICAL DATA IN A COMPUTER-ASSISTED TECHNICAL SOLUTION DESIGN TOOL

(75) Inventors: Soumitra Sarkar, Cary, NC (US); Axel Tanner, Kilchberg (CH)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/099,281

(22) Filed: Apr. 8, 2008

(51) Int. Cl. G06Q 10/00; G06Q 99/00

(52) U.S. Cl. 705/7; 705/1

(57) ABSTRACT

A method and system are disclosed for re-using, across plural customer accounts, information generated as part of technical solution designs by a service provider for delivering Information Technology (IT) outsourcing services to customers. The method comprises the step of providing a set of standard service elements and a set of standard service designs. The method comprises the further steps of customizing one or more of the standard service designs to generate customized service designs, generating custom service elements, and generating custom service designs associated with them. The custom service elements and service designs, and the customized service designs are stored in a tool-specific metadata repository that is accessed to promote reuse of the customizations across plural customer accounts. Usage statistics are utilized to identify when non-standard service elements and designs should be promoted to standard ones, and data mining techniques are used to infer policies associated with the non-standard service designs.

### BACKGROUND OF THE INVENTION

1. Field of the Invention

This invention generally relates to Information Technology (IT) outsourcing services. More specifically, the invention relates to the use of historical data in a computer-assisted technical solution design tool for IT service outsourcing.

2. Background Art

Many companies outsource the administration of various aspects of Information Technology (IT) operations, often referred to as Strategic Outsourcing (SO). Aspects of IT operations that are typically outsourced include server management (including management of Web server, databases, etc. running on those servers), storage management, management of hardware assets (e.g., servers, desktops, laptops, PDAs, software licenses), data network management, help desk operations, etc.

Companies that offer IT outsourcing services go through several phases from initial analysis of the customer requirements and environment, through negotiating and signing a contract, eventually to a steady state, managing those aspects of customer IT operations which have been taken over. There is an initial Engagement phase during which the customer requirements are understood and mapped to elements of the taxonomy of standard services offered by the outsourcing company—to define the scope of the deal. A service taxonomy is a hierarchical grouping of the standard services, and the leaf nodes are referred to as service elements. For requirements that cannot be mapped to standard services, custom service elements are defined. The scope, coupled with initial information about the customer environment that is relevant to the deal (e.g., number of servers of different types, amount of storage, etc., if server management and storage management are to be outsourced) is used to create a cost solution, the purpose of which is to forecast the cost to the outsourcing solution over the projected time period of the contract.

During this phase, the technical solution which identifies the target IT architecture—the software tools, middleware and hardware platforms which will be deployed to provide each contracted service, and optionally any planned transformation of the customer IT infrastructure itself—is also defined. Unless every aspect of customer IT operations that is outsourced involves using existing customer tools and hardware, which is rarely the case, the target IT architecture will identify a different IT environment preferred by the outsourcing company to deliver the services with higher operational efficiencies. The cost and technical solutions, along with identification of Service Delivery Obligations (which covers Service Level Agreements and more) are key inputs for creating the contract.

After contract signing, there is a Transition phase during which customer operations (and often their IT personnel) are taken over by the contracting company “as-is”. During this phase, the task of technical solution refinement is performed, using more accurate information about the customer environment available, e.g., by running discovery tools, which are typically permitted only after contract signing. The revised target IT architecture is the basis for creating a transformation solution, which identifies how the current IT environment (tools/software, middleware, hardware) will be gradually replaced. Next comes the Transformation phase during which the IT infrastructure transformation is performed. Finally the phase involving steady state operations starts, during which contracted services are delivered, operations are monitored for compliance with service delivery obligations specified in the contract, and problem determination and resolution are performed.

Many of the activities that are performed during the engagement, transition and transformation phases are carried out manually. One exception is the creation of the cost solution, for which tooling based on machine representation of rate tables and formulae to project the cost of software, hardware, and labor required to deliver various services is essential, since manually performing hundreds of calculations for the scores or hundreds of standard services to which the customer requirements are mapped could be extremely error prone. The related task of scope definition is also supported with tools that expose the architect to the standard services taxonomy, and allow various service elements to be selected, the resulting information being input to the costing tool

On the other hand, the equally important task of technical solution (architecture) definition, both the initial development during the engagement phase, and the subsequent refinement of the solution during the transition phase, is typically documented without any tooling support other than basic word processing tools such as Word and PowerPoint. As a result, there is no consistency in the quality of the work product. Knowledge of best practices, either documented or tribal in nature, is not applied uniformly since the degree to which that is done is highly dependent on the skill of the solution architect, the time she has to document design details, and the availability of a subject matter expert for consultation.

In the domain of IT outsourcing, the use of standard service taxonomies, and the documented service designs, which describe best practices for delivering “atomic” services (corresponding to leaf-level service elements in the taxonomy), is becoming more prevalent in the industry. However, the best practices documentation is typically unstructured and in natural language, and the end goal is simply the harvesting and storing of expert knowledge in a readable, but not machine processable form. While the technical solution design process in current practice may be based on the philosophy of reusing best practices design components, the service composition procedure is essentially manual, and thus errors could be made in selecting the right designs based on analyzing customer requirements, the current state of the IT environment, and even possible future states, and also in checking for composition rules based on dependencies between various service designs.

An advanced approach for building a knowledge-driven system that can assist with the tasks of creating a technical solution for delivering a set of contracted services for IT outsourcing is described in U.S. patent application Ser. No. 11/773,985 (Attorney Docket: YOR920070221US1) for “A computer-Assisted Information Technology Service Design System,” filed Jul. 6, 2007, the disclosure of which is hereby incorporated herein by reference in its entirety.

The system described in the above-mentioned co-pending U.S. patent application Ser. No. 11/773,985 (Attorney Docket: YOR920070221US1) is an important advancement in the state of the art. This system can be further improved by leveraging a repository of historical information about past designs and custom service taxonomy elements that have been created in various outsourcing engagements.

### SUMMARY OF THE INVENTION

An object of this invention is to improve computer assisted technical solution design tools for Information Technology (IT) outsourcing.

Another object of the present invention is to use historical data in a computer-assisted technical solution design tool for IT service outsourcing.

A further object of the invention is to store and to categorize information, in the form of policies, about customizations created for specific customer accounts in an IT outsourcing service, and to re-use that information in other customer accounts.

These and other objects are attained with a method and system for re-using, across plural customer accounts, information generated as part of technical solution designs by a service provider for delivering Information Technology (IT) outsourcing services to customers. The method comprises the steps of defining the taxonomy of a set of standard service elements, and providing a set of standard service designs associated with said standard service elements. The method comprises the further steps for one or more of the customers, (i) customizing a standard service design associated with a (standard) service element, to create a customized service design, when none of the alternate designs are suitable, (ii) creating a custom service element when none of the standard ones are applicable, and (iii) creating a custom service design associated with a custom service element.

The custom service elements, customized service designs and custom service designs are stored in a technical solution repository. That technical solution repository is accessed to reuse said custom service elements, customized service designs and custom service designs across plural or multiple customer accounts.

In the preferred implementation, the method comprises the further step of storing history and reuse statistics of the custom service elements, customized service designs and custom service designs. For example, this history and reuse statistics may include lists of all of the customer accounts where the customized service designs and the custom service designs were used. Also significant is the storage of information about account environments, the information that is used to evaluate policies to assist with the selection and checking of design selections in the referenced patent application (YOR920070221US1), to automatically determine new policies that can be used to automate the selection and checking of customized and custom service designs. Based on reuse statistics maintained by the system, each of the custom and customized designs may be promoted to a standard design under the control of a domain expert. Also, each of the standard service elements which have associated design selection and checking policies can be assigned an associated design selection signature, which is the union of all variables referenced by the preconditions of all policies associated with that service element. The design selection signature is used to infer new policies for customized service designs associated with standard service elements.

The present invention provides an improvement to the system described in the above-identified co-pending U.S. patent application Ser. No. 11/773,985 (Attorney Docket: YOR920070221US1). That system facilitates the reuse of standard designs in a solution repository, which were associated with service elements (leaf nodes) in a standard services taxonomy. The designs could be used as-is or customized to accommodate specific features of the customer requirements or the IT environment. Additionally, custom service taxonomy nodes could also be created to represent service elements not in the standard taxonomy, to incorporate customer requirements that cannot be mapped to the standard service elements.

In accordance with the preferred embodiment of the present invention, historical information about customizations created for specific customer accounts can be re-used in other accounts. Also, in this preferred embodiment, analysis of the customizations created across multiple accounts in conjunction with account-specific information can be used to identify “rules” representing new selection policies and constraints for the new designs, and to also identify design customization candidates which could be promoted to the authoritative metadata repositories as standard designs based on usage statistics.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a base architecture of a technical solution design system.

FIG. 2 shows a catalog of standard services and designs that may be used in the architecture of FIG. 1.

FIG. 3 shows the architecture of a technical solution design system employing the present invention.

FIG. 4 illustrates the promotion of instance data to the tool's private metadata repositories.

FIG. 5 shows a design selection signature of service elements with one or more standard designs.

FIG. 6 is a block diagram of a computer system that may be used in the practice of the present invention.

### DETAILED DESCRIPTION OF THE PREFERRED EMBODIMENTS

The present invention employs a number of principles. The evolving industry practice is for each outsourcing company to standardize on a service taxonomy based on its core competencies, and to document standard designs for leaf nodes of the taxonomy for reuse, instead of building custom solutions for each customer that is not economically sustainable given the intense competition in the industry. Therefore, any tooling should preferably leverage the best practices knowledge base. Technical solutions for IT outsourcing typically utilize standard designs (for standard services), or variations of standard designs when a minor customization is warranted. Completely custom designs are more of an exception than the rule. Therefore, a technical solution design tool preferably facilitates identification and reuse of standard designs in a given context whenever possible, and provides simple mechanisms to document technical solutions as deltas on standard designs.

A basic technical solution design tool may be based on a few core execution engines, but it tailors itself dynamically (the refresh period is configurable) based on an external set of metadata repositories which describe, using machine consumable representations, various aspects of service design knowledge that are key to customizing the tool's behavior. All metadata repositories are enabled for queries via remote procedure call (RPC) mechanisms such as (but not limited to) SOAP. The identification of machine consumable metadata associated with service design components, and how a metadata-driven tool can leverage that, is an important aspect of the preferred embodiment of the invention.

The use of relational databases as backend metadata and instance data repositories is an important part of the preferred overall system architecture. The metadata read from external repositories is consolidated and represented in a form optimal for the tool in a metadata repository that is private to the tool. Technical solutions created for different customers are preferably stored in one or more backend repositories, as instance data, which represents technical solutions, created for different outsourcing deals (customers).

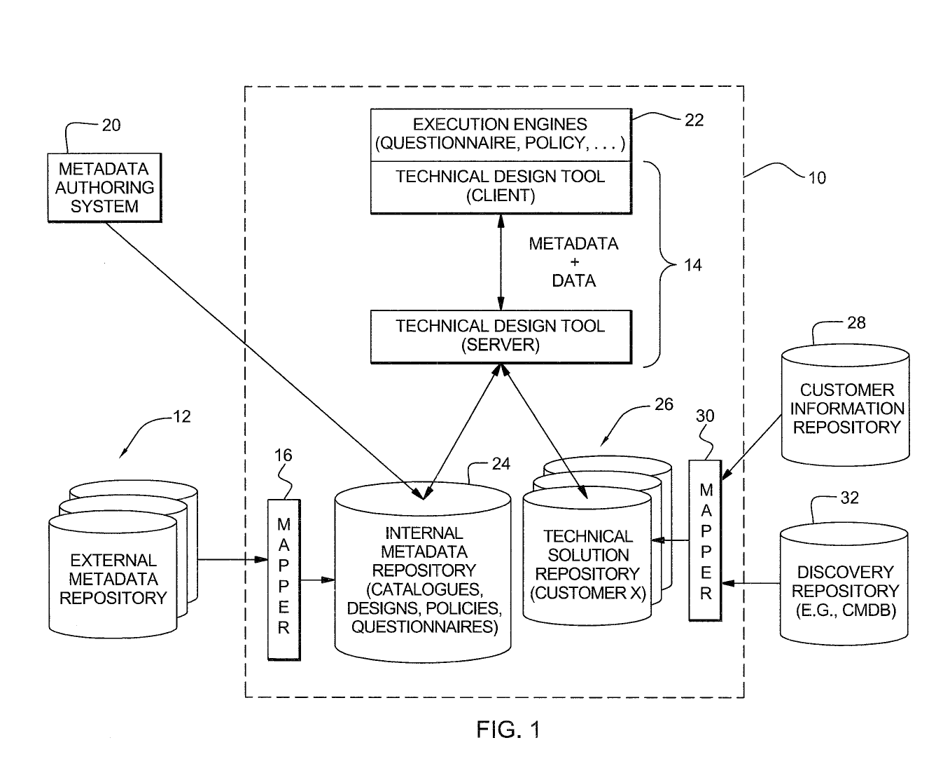

FIG. 1 depicts a base architecture 10 of a technical solution design system, and shows key components and the dependencies on external metadata and data sources. Base architecture 10 is described in detail in the above-identified co-pending patent application Ser. No. ______ (Attorney Docket: YOR920070221US1), the disclosure of which is hereby incorporated herein by reference in its entirety. Generally, in architecture 10, externally defined metadata, represented at 12, (the different types are described below) is read into the system 10 to “prime” the tool 14—via a mapping layer 16 to ensure that the metadata is in a form usable by the design tool. A metadata authoring system 20 allows domain experts to define the “private” metadata, i.e., the metadata used inside the tool, to be added to the internal metadata repository 24 to further customize the tool. An execution engine 22 interprets the metadata to drive tool actions such as the construction of context-specific questionnaires, policy evaluation of architecture compositions, etc.

A set of Technical Solution Repositories 26 store information about solutions created for various contracted services for multiple customers. In earlier phases of the deal, customer environment information that drives the technical solution is input to the tool through questionnaires. In later phases, when customer environment discovery tools can be run, the same “variables” are set by mapping layer 30 by querying the repository 32 populated by such discovery tools, facilitating iterative design refinement and improvement. Information about a customer, such as the customer industry, projected size of the deal, and so on, is also stored in the external Customer Information Repository 28 and is fed into the system through mapping layer 30.

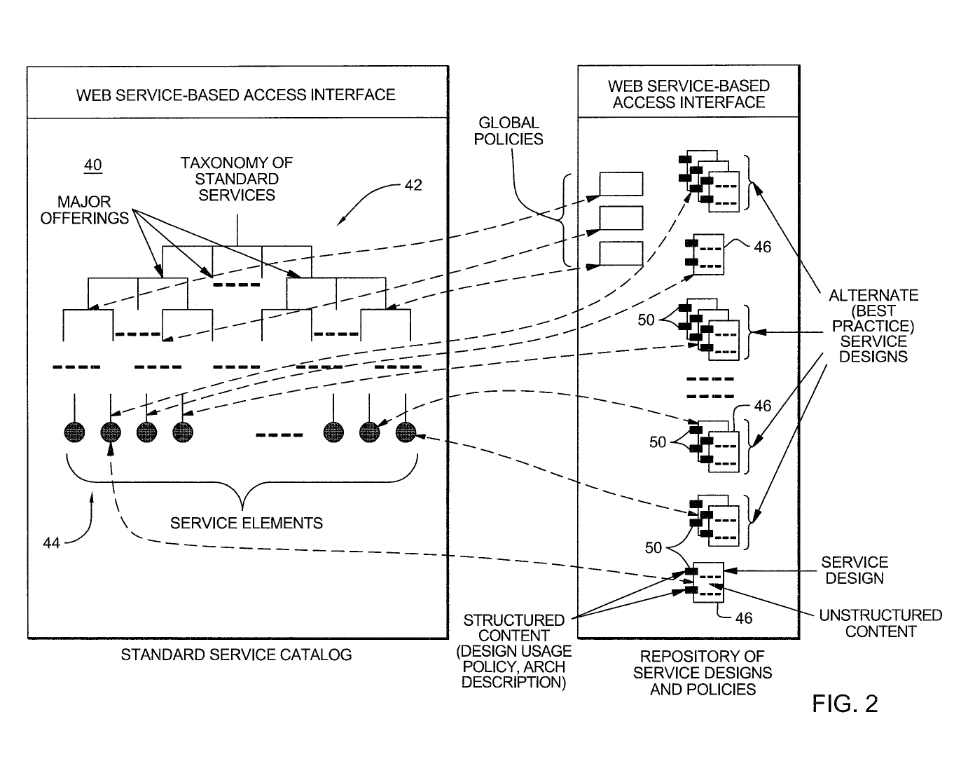

FIG. 2 shows two important categories of metadata used in the preferred embodiment of the system of this invention. The taxonomy of standard services 40 is organized as a hierarchy where the top level nodes under the root represent service offerings 42 (e.g., Mainframe Management, Asset Management, Midrange Server Management, End User Services), whereas the leaf nodes, referred to as Service Elements, 44 represent “atomic” services—such as Windows Server Management, DB2 Database Server Management, etc. under the Midrange Server Management offering. The design repository contains the technical solution definition, which must be implemented to deliver the contracted services to a customer. In the Figure, each rectangle 46 represents a service design, the two darkened boxes 50 within each rectangle represent structured (machine-readable information), and the rest (dotted) is unstructured content.

Occasionally, for one service element there can be alternative solutions. For instance, for a service element such as Backup/Restore Services for Midrange Servers, a simple “tar”-based solution might suffice for a few UNIX servers with direct attached tape drives and simple backup and retention policies, whereas a more complex backup/restore environment involving dozens or hundreds of servers and stringent recovery time objectives could warrant the use of an enterprise tape backup/restore system such as Tivoli Storage Manager with centralized robotics-attached tape drives. Service elements and service designs are discussed in more detail in the above-identified co-pending U.S. patent application Ser. No. 11/773,985 (Attorney Docket: YOR920070221US1).

There are two forms of design customization that can occur in the system shown in FIG. 1 and described in co-pending U.S. patent application Ser. No. 11/773,985 (Attorney Docket: YOR920070221US1). One form of customization is the modification to a standard design, e.g., the modification of a standard way of delivering logical database administration to accommodate the condition that some database servers in the customer environment have less than 25% free space available, which is a violation of one of the preconditions for using the design as-is.

A second type of customization involves creating a completely new service design, to accommodate a customer requirement or environment-related condition that violates the selection policies of all designs associated with that service element. An example of the latter is the creation of a service design for delivering the “Windows server management” service to a customer that has several Windows servers running Citrix. In this case, the design is completely custom—referred to as a one-off—and a custom service element (identified as, say, “Windows server management for Citrix”) is created in the standard taxonomy to associate the custom design with.

Both types of customizations create new instance data in the technical solution. The present invention provides a system and method for reusing that information across multiple accounts as “derived metadata” which extends the functionality of the external metadata, allowing additional knowledge to be made available for technical solution design.

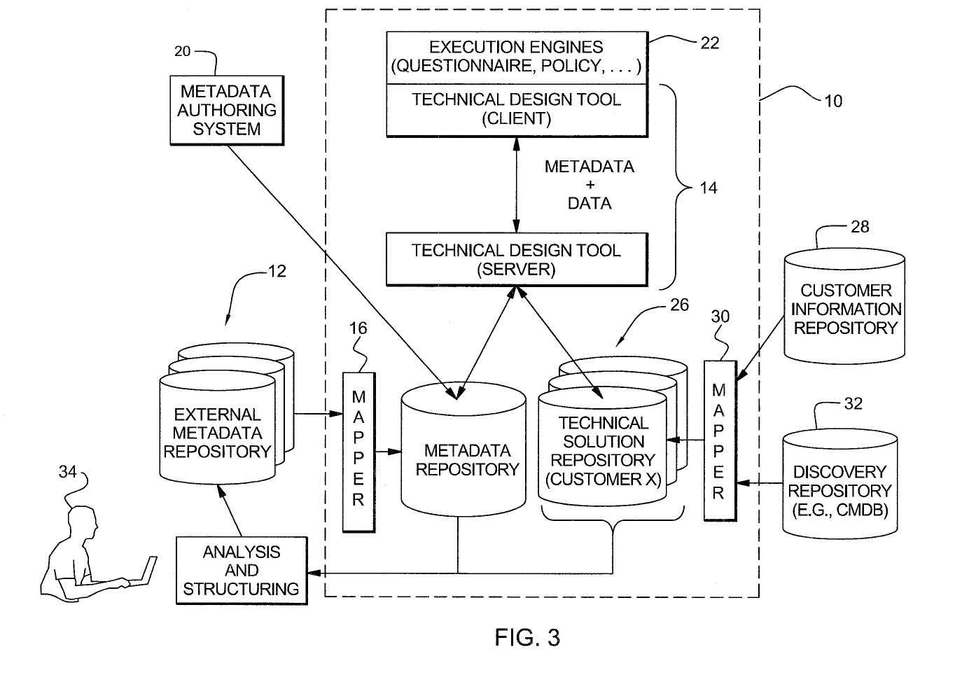

FIG. 3 illustrates how the architecture of the history-aware system of this invention extends the capabilities of the system of FIG. 1 with derived metadata. Refreshing of the system metadata repository from external (standard) metadata repositories does not overwrite the history-based derived metadata.

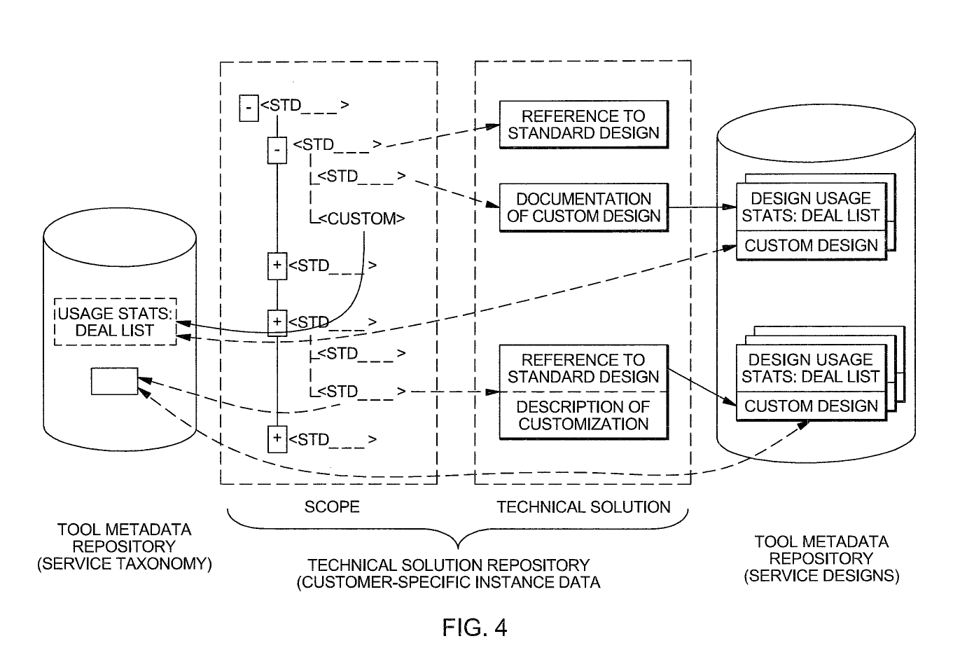

FIG. 4 illustrates derived metadata comprised of custom service taxonomy nodes, as well as customized (or completely custom) designs, which have been created in various accounts.

### Reuse of Custom Service Taxonomy Elements

With reference to FIG. 4, with the additional metadata supplementing the standard service taxonomy, when the technical solution architect needs to create a custom service element, she can query custom elements created in past engagements, and if an appropriate service element is found, reuse that (nonstandard) definition rather than create yet another custom service element. When an architect creates a custom service element, she is prompted to provide a short description (in addition to a meaningful name) for the custom service element. This information, along with the position of the custom service element in the standard service taxonomy, is saved in the system metadata repository. This description will be read by solution architects in the future to decide if the custom element is appropriate for reuse.

The metadata repository keeps track of the accounts where such custom service elements are being reused across engagements. Analysis of reuse statistics such as reuse frequency, industry, deal size, etc., can be used by an administrator to determine if the custom service element is significant or strategic enough to warrant its promotion to the standard service taxonomy.

### Reuse of Nonstandard Service Designs

Custom designs associated with custom service elements, as well as customizations of standard designs associated with standard service elements, are also moved to the system's private metadata repository.

When a standard service design has to be customized, the solution architect can query customizations that have been created in the past for that service element. Either an existing design created in the past is reused, or a new one is created, tagged (with a unique identifier and a meaningful description) and added to the system metadata repository for potential reuse in the future.

When a solution architect reuses a previously created custom service element in the taxonomy, she can query the system for custom designs for that service element which might have been created in the past. If a suitable one is found, it can be reused. Otherwise, a new or alternate (if not the first) custom design is created for the custom service element, which is inserted into the system metadata repository for potential future reuse.

### Analysis of Design Reuse Statistics

As in the case of custom service elements, the key piece of information that is stored with each custom or customized design in the private metadata repository is the list of accounts where that design was reused. Besides a reuse count, information about the different account environments in which a specific service design was reused can be used to understand the implicit policies and constraints that would govern the use of such a design, if it is promoted to the standard design repository.

Data mining techniques can be used to derive classification rules from a sample data set, which enumerates how different combination of values of a set of attributes map to a finite set of results. In the design reuse data, the result set is the set of all custom or customized standard designs that have been created in various accounts. The attributes that potentially have a role in determining the design choice can vary based on the type of design being reused and are described below. The key idea is that classification rules derived using well-understood data mining techniques, using the historical design usage information stored in the system repository, can be leveraged to determine new design selection policies and design constraints that can be associated with the new designs. These designs do not exist in the (external) metadata repository of standard designs and therefore, there are no policies associated with their use. If a domain expert, represented at 34 in FIG. 3, analyzing the historical design usage data decides to promote a custom design to a standard design, the results of the data mining-based analysis can be used to determine the policies to be associated with this newly promoted design.

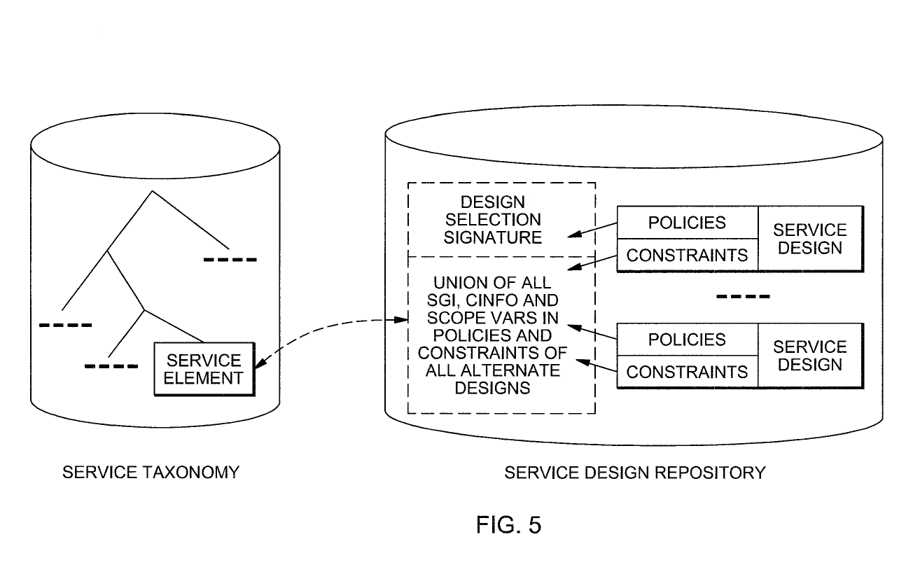

For all customizations of standard designs associated with a standard service element, one set of candidate attributes for analysis is the union of all SGI, CInfo, and scope variables that appear in the preconditions and policies of all alternate designs for that service element, since according to the subject matter expert who created that design metadata, those are the important factors to consider when choosing one of the standard designs. This set of variables constitutes a design selection signature for that service element, and is illustrated in FIG. 5. The concept of SGI (Solution Guidance Input) variables whose values are typically solicited via questionnaires, CInfo (customer info) variables whose values are set by querying customer information repositories such as 28 in FIG. 1, and scope variables—one Boolean-valued variable per leaf-level service element, which is set to true if the service element corresponding to it is selected as part of the customer offering in the technical solution—have been described in detail described in the co-pending U.S. patent application Ser. No. 11/773,985 (Attorney Docket: YOR920070221US1).

For custom designs associated with custom service elements, there are no standard designs, and thus no policy (precondition) metadata to guide the selection of attributes to use for machine inference of design reuse rules. In general, even the identification of the design selection signature for standard service elements is only a heuristic and the set of attributes identified using that technique might not be enough to derive meaningful classification rules for new customized designs. To be fully general, the system allows the administrator to manually select the attributes to consider for analysis. The global set of attributes is comprised of all possible scope and CInfo variables—which is a finite set determined by the number of nodes in the service taxonomy and the number of customer information entities supported. The global set of SGI variables is the union of all such variables that appear in various policies and preconditions in the entire standard design metadata, plus the variables that appear in manually created questionnaires which may not be used in any policy (yet). That is a finite but potentially large set. When analyzing a set of custom service designs to infer usage policies, it is probably safe to start with an attribute list limited to those associated with a given offering (e.g., mainframe management, help desk, server management) in the taxonomy and then prune the list further based on domain knowledge. This would not be a fully automated process but would require input from domain experts.

### Querying Design History

Once the repository of custom and customized designs grows, a query facility will be useful. A simple extension of the interface used to control machine analysis of design reuse rules can be used to query the system for nonstandard designs that have been used in the past—by defining predicates for various attributes. One could look for designs that have been defined in the past for specific customer environments, e.g., in a specific industry or country (CInfo variables), or perhaps with an unusually high proportion of database and SAP servers (SGI variables).

Techniques used to identify and present the minimal set of attributes to consider for machine analysis can also be used to help the user formulate a query to locate an appropriate service design for a service element, or perhaps a set of designs corresponding to an intermediate node in the service taxonomy.

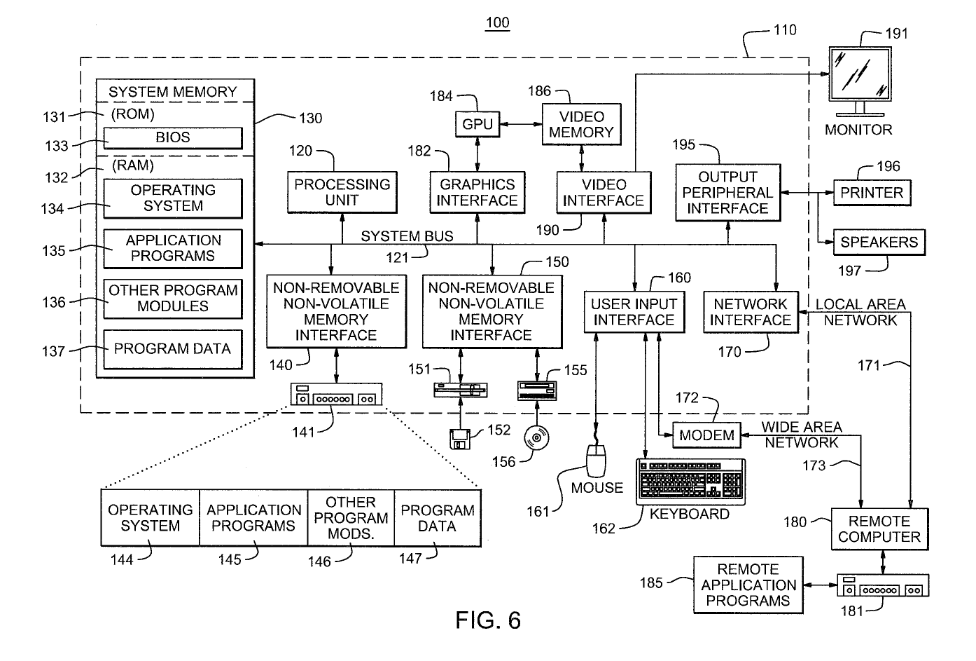

The method of the present invention will be generally implemented by a computer executing a sequence of program instructions for carrying out the steps of the method and may be embodied in a computer program product comprising media storing the program instructions. For example, FIG. 6 and the following discussion provide a brief general description of a suitable computing environment in which the invention may be implemented. It should be understood, however, that handheld, portable, and other computing devices of all kinds are contemplated for use in connection with the present invention. While a general-purpose computer is described below, this is but one example, the present invention may be implemented in an environment of networked hosted services in which very little or minimal client resources are implicated, e.g., a networked environment in which the client device serves merely as a browser or interface to the World Wide Web.

Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 6, thus, illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 6, an exemplary system for implementing the invention includes a general purpose-computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 4 illustrates operating system 134, application programs 135, other program modules 136, and program data 137.

The computer 110 may also include other removable/non-removable, volatile/nonvolatile computer storage media. By way of example only, FIG. 6 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 6 provide storage of computer readable instructions, data structures, program modules and other data for the computer 110. In FIG. 6, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host-processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of co-processing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 4. The logical connections depicted in FIG. 4 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 6 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of re-using information across plural customer accounts, said information being generated as part of technical solution design by a service provider for delivering Information Technology (IT) outsourcing services to customers, the method comprising the steps of:
providing a definition of the taxonomy of a set of standard service elements;
providing a set of standard service designs associated with said standard service elements;
for one or more of the customers, (i) customizing one or more of the standard service designs to generate customized service designs, (ii) generating custom service elements, and (iii), generating custom service designs;
storing said customized service designs, custom service elements, and custom service designs in a technical solution repository; and
accessing said technical solution repository to reuse said customized service designs, custom service elements, and custom service designs across plural customer accounts.

2. A method according to claim 1, comprising the further step of storing history and reuse statistics of the customized service designs, custom service elements, and custom service designs.

3. A method according to claim 2, wherein the step of storing history and reuse statistics includes the steps of:
for each of the customized service designs, storing a list of all of the customer accounts where the customized service design was used;
for each of the custom service elements, storing a list of all of the customer accounts where the custom service element was used; and
for each of the custom service designs, storing a list of all of the customer accounts where the custom service design was used.

4. A method according to claim 1, comprising the further step of, for each of the custom and customized designs, promoting the design to a standard design if said each design meets given criteria, and promoting each of the custom service elements to a standard service element of said each custom service element meets defined criteria.

5. A method according to claim 1, comprising the further step of assigning to each of at least some of the standard service elements an associated design selection signature.

6. A method according to claim 5, wherein the design selection signature for each of said at least some of the standard service elements are based on the variables used in the preconditions of the policies associated with the standard service element.

7. A method according to claim 1, comprising the further steps of:
identifying a set of attributes for analyzing the custom service designs; and
assigning to each of the custom service designs, a subset of said attributes; and wherein
the accessing step includes the step of analyzing the custom service designs based on the subsets of attributes assigned to the custom service designs, to infer classification rules, to identify policies that define when those custom service designs can be selected in a given customer environment.

8. A method according to claim 1, comprising the further steps of:
identifying a set of attributes for analyzing the customized service designs;
assigning to each of the customized service designs, a subset of said attributes; and
wherein the accessing step includes the step of analyzing the customized service designs based on the subsets of attributes assigned to the customized service designs to infer classification rules, to identify policies that define when those customized service designs can be selected in a given customer environment.

9. A method according to claim 8, comprising the further steps of:
for each of the custom service elements, identifying a place for said custom service element in said taxonomy of the set of standard service elements.

10. A system for providing automated assistance to a service provider for creating a technical solution definition for a project for delivering Information Technology (IT) outsourcing services for a customer, the system comprising:
a first metadata repository for providing, in machine processable form, a definition of the taxonomy of a set of standard service elements;
a second metadata repository for providing, in machine processable form, a set of standard service designs associated with said standard service elements;
a computer implemented design tool to define a scope of the project, to navigate through said taxonomy, and to select a group of service elements for defining a solution for delivering said IT outsourcing services;
for one or more of the customers, (i) customizing one or more of the standard service elements to generate customized service elements, (ii) generating custom service elements, (iii) customizing one or more of the standard service designs to generate customized service designs, and (iv) generating custom service designs;
a technical solution repository for storing, in machine processable form, customized service elements, custom service elements, customized service designs and custom service designs; wherein said customize service elements are generated by customizing one of the standard service elements, and said customized service designs are generated by customizing one of the standard service designs; and
accessing said technical solution repository to reuse said customized service elements, custom service elements, customized service designs and custom service designs across plural customer accounts.

11. A system according to claim 10, wherein the historical repository stores history and reuse statistics of the customized service elements, custom service elements, customized service designs and custom service designs.

12. A system according to claim 11, wherein the history and reuse statistics includes:
for each of the customized service designs, storing a list of all of the customer accounts where the customized service design was used; and
for each of the custom service designs, storing a list of all of the customer accounts where the custom service design was used.

13. A system according to claim 12, wherein a design selection signature is assigned to each of at least some of the standard service elements.

14. A method according to claim 13, wherein the design selection signature for each of said at least some of the standard service elements is based on preconditions and policies for the standard service element.

15. A method according to claim 10, wherein:
each of the custom and customized designs are promoted to a standard design when said each design meets given criteria; and
each of the custom service elements are promoted to a standard service element when said each custom service element meets defined criteria.

16. A program storage device readable by machine, tangibly embodying a program of instructions executable by the machine to perform method steps for re-using information across plural customer accounts, said information being generated as part of technical solution designs by a service provider for delivering Information Technology (IT) outsourcing services to customers, the method steps comprising:
providing a definition of the taxonomy of a set of standard service elements;
providing a set of standard service designs associated with said standard service elements;
for one or more of the customers, (i) customizing one or more of a set of given standard service elements to generate customized service elements, (ii) generating custom service elements, (iii) customizing one or more of a set of given standard service designs to generate customized service designs, and (iv) generating custom service designs;
storing said customized service elements, custom service elements, customized service designs and custom service designs in a technical solution repository; and
accessing said technical solution repository to reuse said customized service elements, custom service elements, customized service designs and custom service designs across plural customer accounts.

17. A program storage device according to claim 16, wherein the method steps comprise the further step of storing history and reuse statistics of the customized service elements, custom service elements, customized service designs and custom service designs.

18. A program storage device according to claim 17, wherein the step of storing history and reuse statistics includes the steps of:
for each of the customized service designs, storing a list of all of the customer accounts where the customized service design was used;
for each of the custom service elements, storing a list of all of the customer accounts where the custom service element was used; and
for each of the custom service designs, storing a list of all of the customer accounts where the custom service design was used.

19. A program storage device according to claim 18, comprising the further step of, for each of the custom and customized designs, promoting the design to a standard design if said design meets given criteria.

20. A program storage device according to claim 16, wherein:
each of the custom and customized designs are promoted to a standard design when said each design meets given criteria; and
each of the custom service elements are promoted to a standard service element when said each custom service element meets defined criteria.
